(19) United States
(12) Patent Application Publication
(10) Pub. No.: US 2016/0161057 A1
(43) Pub. Date: Jun. 9, 2016

(54) METHOD FOR MANUFACTURING NON-CYLINDRICAL TYPE PRESSURE VESSEL HAVING HARDY BULKHEAD

(71) Applicant: Hyundai Motor Company, Seoul (KR)

(72) Inventors: Hyun Min KANG, Seongnam-si (KR); Seung Jeong OH, Seoul (KR); Woo Min KYOUNG, Yongin-si (KR); Jun Ho JANG, Yongin-si (KR)

(21) Appl. No.: 14/871,513

(22) Filed: Sep. 30, 2015

(30) Foreign Application Priority Data
Dec. 3, 2014 (KR) 10-2014-0172503

(51) Int. Cl. F17C 1/02; B29D 22/00

(52) U.S. Cl. CPC F17C 1/02; B29D 22/003; B29K 2707/04

(57) ABSTRACT

A method for manufacturing a pressure vessel includes blow-molding a liner vessel in a shape having at least one bulkhead and two or more separated spaces and inserting a bulkhead reinforcing plate between the separated spaces. The method further includes forming an outer layer comprising a glass fiber or a glass fiber-carbon fiber composite material on the outside of the liner vessel and forming at least one anchor site configured to couple the bulkhead reinforcing plate to the outer layer.

### CROSS-REFERENCE TO RELATED APPLICATION

This application claims under 35 U.S.C. §119(a) the benefit of priority to Korean Patent Application No. 10-2014-0172503 filed on Dec. 3, 2014, the entire contents of which are incorporated herein by reference.

### TECHNICAL FIELD

The present disclosure relates to a method for manufacturing a non-cylindrical pressure vessel having a hardy bulkhead. More particularly, it relates to a method for manufacturing a new pressure vessel capable of forming a hardy bulkhead, while having high rigidity in a simple and economical way, by inserting a thermoplastic carbon fiber composite material plate into a liner shape having a separated space when forming a bulkhead of a non-cylindrical pressure vessel.

### BACKGROUND

In general, the pressure vessel having the bulkhead is used to charge a gas at a high pressure, fabricated-shaped or cylindrical pressure vessels have been developed and used, and recently, individually related research of the non-cylindrical pressure vessels has been actively promoted.

In the case of the fabricated pressure vessel, as a working pressure is a high pressure, since problems occur in a joining or sealing site of a connecting site occur, it is preferable to apply an integrated structure. In particular, since the most existing pressure vessel shapes are configured on the basis of a steel material, it is not desirable to apply them to a passenger car in which lightweight is important. In addition, although the vehicle requires installation of a pressure vessel having a constant volume or more for securing a cruising distance, two or more pressure vessels of small volume are applied as the cylindrical pressure vessel due to the limited mounting space, and there is a problem in that the mounting efficiency is lowered due to unnecessary space that occurs when mounting such a two or more cylinders.

Thus, as compared to the conventionally known cylindrical pressure vessel, the non-cylindrical pressure vessel has advantages that has excellent space utilization, has no problems with joining and sealing by solving the problems of the cylindrical pressure vessel as described above due to the integrated form, and can also reduce weight and cost by reduction of valves and fittings.

As the prior art relating to the pressure vessel, US Patent Publication No. 2009/0050635 has an integral shape, and it maintains a cylindrical shape as it is, and has a problem of existence of an unnecessary space. U.S. Pat. No. RE41,142 E (2010) discloses pressure vessels which maintain the different shapes from each other, but there are problems that a lot of production costs are consumed and the pressure vessels are manufactured to a level of high weight. In addition to this, in the case of the working pressure being a high pressure of 150 bar or more, there is a problem that the joining and sealing states of the connection site do not secure the safety in the pressure vessel having the fabricated shape.

Considering non-cylindrical pressure vessels which have been conventionally developed, Thiokol Propulsion's vessel is constituted by a carbon fiber-epoxy composite material and a plastic liner, by manufacturing the outside by performing the filament winding using the continuous fibers, suggests a pressure vessel which provides a high space-efficient structure as compared to the case of using a plurality of cylindrical shapes, and suggests a technique of ensuring a maximum load capacity through changes of the internal structure. In addition, recently, in 2009-2013 SAGANE Project [French Gov.], a development of a pressure vessel configured in a rectangular mounting form has been attempted by forming a liner through the blow molding and forming the outside thereof with a glass fiber material and a reinforced material such as epoxy, by French industry-university cooperation development. An improvement in the vessel is planned in dispersibility of dispersing the pressure by utilizing a liner engraving projection.

However, although such existing pressure wall vessels exhibit the development success to some extent, they still have not been put to practical use, and since the manufacturing process is uneconomical, the possibility of the future mass production seems to be thin.

Such pressure vessels are generally classified in four forms depending on the material and the structure. That is, they are classified into a form which uses only existing steel material (type 1), a form in which only the cylinder portion is selectively reinforced with a glass fiber material in the steel material liner (type 2), a vessel form in which the entire outer layer is reinforced with glass fiber and carbon fiber composite material in a liner made of a steel material such as aluminum (type 3), and a form in which the entire outer layer is reinforced with a glass fiber and a carbon fiber composite material in a liner made of a polymer material (type 4).

Although the type 1, which has been cheapest in the cost and commonly used, has been universally and widely used, as the related art of type 4 has been actively developed recently according to the weight reduction and the stability issue, recently, there has been a tendency that the usage of type 4 has significantly increased. As a prior art relating to this, U.S. Pat. No. 8732929 relates to a method for manufacturing a high-pressure gas tank of a vehicle which reduces a weight, and suggests a vessel in which an interior is formed of polyamide 6 resin and an outer peripheral surface is formed by filament-winding of a reinforcing fiber layer. Korean Patent Laid-Open No. 2014-0041868 suggests a technique of manufacturing a pressure vessel, by forming a hollow vessel by a polyamide resin rather than a metallic material, by performing the filament winding molding on the surface using fiber material, and by radiating ultraviolet rays. However, the vessel has a single cylindrical structure having a bulkhead in the interior.

Moreover, as the pressure vessel having the inner bulkhead, Japanese Patent Publication No. 1997-0042594 suggests a method of manufacturing an inexpensive lightweight pressure vessel, and a configuration in which a bulkhead is formed in the interior and a FRP reinforcing layer is installed on the outer circumference so as to reinforce the liner. Further, Japanese Patent Publication No. 2001-0254894 suggests, as a liquefied gas storage insulation vessel, a non-cylindrical pressure vessel which is adjustable depending on the capacity, by forming a plurality of reinforcing ribs in the interior.

However, these pressure vessels have problems in that the bulkhead is pushed due to high pressure since the bulkhead is not strong, they are not very practical, and they do not properly solve the conventional problems.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present disclosure has been made in an effort to solve the above-described problems associated with prior art.

In one aspect, especially, an embodiment of the present invention provides a non-cylindrical pressure vessel having a bulkhead as a pressure vessel of type 4 which is manufactured so as to be able to be simply and economically manufactured while having a hardy bulkhead.

In certain embodiments, the present invention provides a method for manufacturing a non-cylindrical pressure vessel having a hardy bulkhead in a simple and economical manner.

In certain embodiments, the present invention provides a non-cylindrical pressure vessel which is excellent in space utilization and is suitable for automotive, since it is formed of a material of type 4 and has the bulkhead of high rigidity that is also robust for the pressure of the high pressure.

In order to solve the above-described problems, a method for manufacturing a pressure vessel includes blow-molding a liner vessel in a shape having at least one bulkhead and two or more separated spaces, inserting a bulkhead reinforcing plate between the separated spaces, forming an outer layer including a glass fiber or a glass fiber-carbon fiber composite material on the outside of the liner vessel, and forming at least one anchor site configured to couple the bulkhead reinforcing plate to the outer layer.

In certain embodiments, the bulkhead reinforcing plate may be made of a thermoplastic carbon fiber composite material.

In certain embodiments, the forming of the outer layer may include applying a filament winding.

In certain embodiments, the liner vessel may include Polyamide 6 material having low gas permeability.

In certain embodiments, the bulkhead reinforcing plate may be configured to be separated into left and right sides or upper and lower sides and to be fastened to the at least one bulkhead of the liner vessel from the left and right sides or the upper and lower sides.

In certain embodiments, in the forming of the at least one anchor site, the anchor site may be manufactured separately from the bulkhead reinforcing plate.

In certain embodiments, in the forming of the at least one anchor site, the at least one anchor site may be formed integrally with the bulkhead reinforcing plate. In certain embodiments,

In certain embodiments, the at least one anchor site may be protrusion-molded.

In certain embodiments, the at least one anchor site may include two or four anchor sites formed at symmetric positions.

Further, an embodiment of the present invention provides a pressure vessel including a liner vessel made of a plastic material having at least one bulkhead and two or more separated spaces. A bulkhead reinforcing plate is configured to reinforce the at least one bulkhead of the liner vessel by being inserted between the separated spaces of the liner vessel An outer layer includes a glass fiber or a glass fiber-carbon fiber composite material and is formed on the outside of the liner vessel. An anchor site is provided at an outer surface of the outer layer and the bulkhead reinforcing plate and is configured to prevent the bulkhead reinforcing plate from being displaced due to pressure.

In certain embodiments, the at least one anchor site may be manufactured separately from the bulkhead reinforcing plate.

In certain embodiments, the at least one anchor site may be formed integrally with the bulkhead reinforcing plate.

In certain embodiments, the at least one anchor site may be protrusion-molded.

In certain embodiments, the at least one anchor site may include two or four anchor sites formed at symmetric positions.

In certain embodiments, the outer layer may be formed on the outside of the liner vessel by applying filament-winding.

In certain embodiments, a vehicle may include various embodiments of the pressure vessel described herein.

According to embodiments of the present invention, when manufacturing a pressure vessel which includes a liner vessel made of a plastic material and an outer layer formed of a glass fiber or a glass fiber-carbon fiber composite material, it is possible to manufacture a safety pressure vessel having a hardy bulkhead, by inserting the reinforcing plate to the bulkhead of the liner vessel corresponding to the internal vessel, and by coupling the bulkhead to the outer layer so as to be strongly fixed, using the anchor site which permits the reinforcing plate to be coupled with the outer layer, thereby preventing the bulkhead from being pushed even at a high pressure.

Further, the method for manufacturing the pressure vessel according to certain embodiments of the present invention, since it is possible to manufacture a pressure vessel having a hardy bulkhead by a simple process such as insertion of the bulkhead reinforcing plate and the fixedly coupling using the anchor site, there is an effect that it is possible to simply and economically manufacture a pressure vessel in which safety is secured.

Other aspects and preferred embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

### BRIEF DESCRIPTION OF THE DRAWINGS

The above and other features of embodiments of the present invention will now be described in detail with reference to the accompanying drawings which are given hereinbelow by way of illustration only, and thus are not limitative of the present invention, and wherein:

FIG. 1 is a diagram schematically illustrating a cross-sectional shape of a non-cylindrical pressure vessel having a bulkhead according to an embodiment of the present invention;

FIG. 2 is an exemplary diagram illustrating an embodiment in which an anchor site is integral with the bulkhead reinforcing plate; and

FIG. 3 is an exemplary diagram illustrating an appearance of a non-cylindrical pressure vessel according to one embodiment and includes a partial cross-sectional shape thereof.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While embodiments of the invention are described below, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, embodiments of the present invention will be described in more detail as follows.

Embodiments of the present invention include a method for manufacturing a non-cylindrical new concept pressure vessel of type 4 form which is manufactured in a manner in which, after a liner vessel made of a plastic material is manufactured in a form having separated spaces, a bulkhead reinforcing plate having very excellent rigidity and a very thin thickness is inserted into the portion of the separated spaces, and then, an outer layer is formed by performing a filament winding using a glass fiber or a glass fiber-carbon fiber composite material, wherein the liner vessel and the bulkhead reinforcing plate are strongly fixed by the anchor site.

According to embodiments of the present invention, in order to manufacture a non-cylindrical pressure vessel having a hardy bulkhead, the liner vessel made of the plastic material may be formed in a form in which the internal space is separated using the bulkhead.

According to certain embodiments of the present invention, one or more bulkheads are formed inside the liner vessel. In certain embodiments, the liner vessel may be formed of the plastic material and is blow-molded so as to have two or more space portions. In certain embodiments, the liner vessel may be formed of the plastic material. In certain embodiments, the liner vessel may be formed of a plastic material comprising a Polyamide 6 material having low gas permeability.

According to embodiments of the present invention, the bulkhead reinforcing plate is inserted into the bulkhead forming site of the liner vessel to form the bulkhead.

According to certain embodiments of the present invention, as the bulkhead reinforcing plate capable of serving to the bulkhead of the high rigid material in the liner vessel shape of the separated spaces, for example, since a hardy bulkhead can be formed in a manner of inserting the thermoplastic carbon fiber composite material plate, it can be manufactured by a simple and excellent production method. Also, the bulkhead reinforcing plate can be easily manufactured by compression-molding of thermoplastic carbon fiber composite material, and, in certain embodiments, can ensure excellent productivity by manufacturing it by a simple process within 1 minute as a cycle time.

A process of manufacturing a non-cylindrical pressure vessel having a hardy bulkhead according to certain embodiments of the present invention will be more specifically described as an example.

In certain embodiments, the overall shape of a new concept pressure vessel may be a rectangular shape having a smooth curved surface, which has excellent vehicle mounting characteristics. An excellent pressure dispersion effect can be obtained by separating the internal space into two or more spaces by utilizing one or more bulkheads.

According to certain embodiments of the present invention, it is possible to increase the number of separation bulkheads which separate the internal space according to the capacity of the pressure vessel. For example, in certain embodiments, a vessel of below 45 L can be manufactured in a form of being divided into two space portions by one bulkhead. Also, in certain embodiments, vessels of 46 to 100L can be configured by being divided into three spaces by two bulkheads.

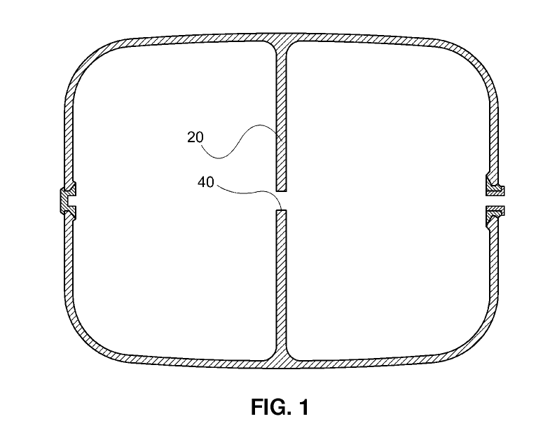

According to certain embodiments of the present invention, the cross-sectional shape of the non-cylindrical pressure vessel having the bulkhead is intended to implement a pressure dispersion effect through the internal space division in the pressure vessel. For example, in certain embodiments, an inner liner vessel is manufactured in a cross-sectional shape having one bulkhead as illustrated in FIG. 1. In certain embodiments, the inner liner vessel may be made of Polyamide 6. In certain embodiments, for a strong bulkhead reinforcement, a bulkhead reinforcing plate based on the thermoplastic carbon fiber composite material may be inserted into the bulkhead portion. In certain embodiments, the liner vessel forming the interior of the pressure vessel can be manufactured by blow-molding a plastic material, and after molding the liner vessel, the bulkhead reinforcing plate may be inserted into the inner bulkhead portion of the liner vessel so as to complement the rigidity of the bulkhead.

According to certain embodiments of the present invention, since the bulkhead reinforcing plate can be manufactured in a thin form as it has excellent rigidity, a material having a tensile modulus of 50 GPa or more is suitably used. In certain embodiments, in order to ensure weight reduction and excellent productivity, a plate based on the thermoplastic carbon fiber composite material may be used. For example, as the bulkhead reinforcing plate, it is possible to suitably use 60 to 70 weight % carbon fiber composite material (CF=Toray's T700) based on Polyamide 6.

In certain embodiments, the bulkhead reinforcing plate can be manufactured so that it can be separated into left and right sides or upper and lower sides, and can be mounted in the form of being inserted and fastened into the bulkhead portion of the liner vessel from the left and right sides or the upper and lower sides.

In certain embodiments, after the bulkhead reinforcing plate is inserted into the bulkhead portion of the liner vessel as described above, in the outer layer portion of the liner vessel, an outer layer comprising glass fiber or glass-carbon fiber may be formed in the form of a hybrid composite material, and it can be manufactured by Type 4. In certain embodiments, the outer layer may be formed by applying a filament winding.

According to certain embodiments of the present invention, in order that the bulkhead positioned in the inner liner vessel is strongly fixed to the outer layer and can withstand without being substantially displaced by a high pressure, an anchor site may be formed, in which the outer layer of the glass fiber or glass fiber-carbon fiber composite material and the bulkhead reinforcing plate are fixed in a rigidly fastened form. In certain embodiments, a strong bulkhead is formed in a form in which the anchor site protrudes and is fixed to the bulkhead reinforcing plate.

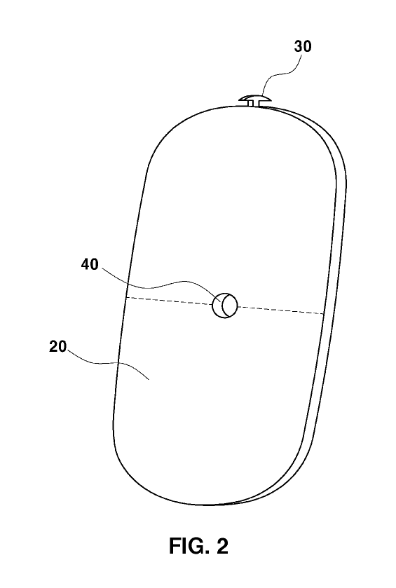

According to certain embodiments of the present invention, the anchor site can be formed in the form illustrated in FIG. 2. In FIG. 2, reference numeral 20 is a bulkhead reinforcing plate, reference numeral 30 is an anchor site, and a reference numeral 40 is a hole formed in the bulkhead. In certain embodiments, the bulkhead reinforcing plate is inserted and mounted in a bulkhead portion located in a divided region of the liner vessel, and then is fixed so as to be able to be integrated with an outer layer formed of a composite material to secure the rigidity. In certain embodiments, two anchor sites may be applied to mutually symmetrical positions, and in order to configure a more rigid and strong bulkhead, four or more anchor sites may be included. In certain embodiments, these anchors sites can be manufactured in a form separated from the bulkhead reinforcing plate and can be used by being inserted, for example, in the form of bolt. In other embodiments, the anchor sites can be integrally molded to reflect the die shape at the time of molding of the bulkhead reinforcing plate, which in certain embodiments may include thermoplastic carbon fiber composite material. In certain embodiments, the molding may be compression molding or protrusion molding.

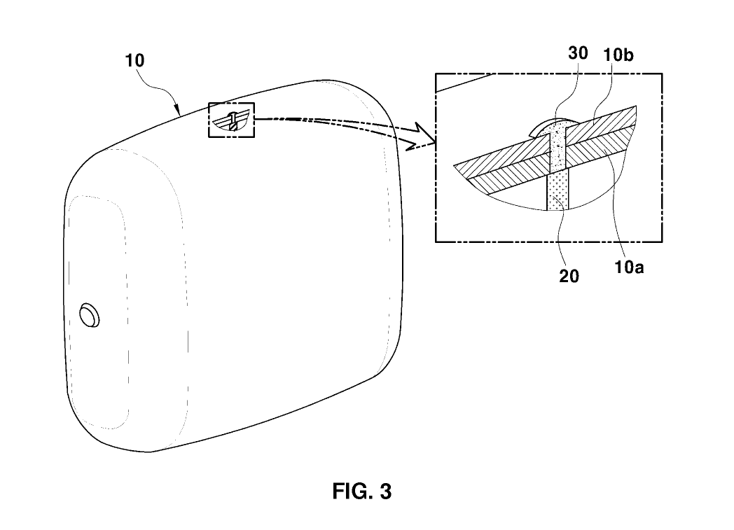

According to an embodiment of the present invention, as illustrated in FIG. 3, the anchor site may be molded in the form of being integrated with the bulkhead reinforcing plate and configured in the manufactured form. In FIG. 3, it is possible to see a cross-section of a portion of the pressure vessel 10 to which the anchor site 30 is applied. Here, reference numeral 10a is a liner vessel, reference numeral 10b is an outer layer, reference numeral 20 is a bulkhead reinforcement plate, and reference numeral 30 is an anchor site.

According to embodiments of the present invention, a pressure vessel 10 manufactured by the structure as described above has a very rigid bulkhead and can maximize the pressure dispersion effects without being substantially displaced, deformed or bent even at a high pressure, and thus it is possible to provide a non-cylindrical pressure vessel of a safety form.

According to embodiments of the present invention, when manufacturing the non-cylindrical pressure vessel having the hardy bulkhead as described above, by manufacturing it by a method of applying the bulkhead reinforcing plate and the anchor site, it is also possible to form a very strong bulkhead even by a very simple process, and it is possible to very economically manufacture the pressure vessel.

According to embodiments of the present invention, the non-cylindrical pressure vessel having the hardy bulkhead can be configured to have a non-cylindrical appearance such as is illustrated in FIG. 3. However, the shape of the non-cylindrical pressure vessel is not limited to the shape shown in FIG. 3.

Thus, according embodiments of to the present invention, it is possible to provide a new concept non-cylindrical pressure vessel which includes the liner vessel made of the plastic material having one or more bulkheads, the bulkhead reinforcing plates, the outer layer formed of the glass fiber or glass fiber- carbon fiber composite material, and the anchor site for rigid reinforcement of the bulkhead reinforcing plate as described above.

According to embodiments of the present invention, as a non-cylindrical pressure vessel capable of dispersing the pressure by the installation of the bulkhead and having the separable internal space, it is possible to further ensure the additional useful space of the volume of 8 to 23% through the appropriate design of the shape as described above, and the number of pressure vessels required in a given application can be reduced. Thus, in the case of applying the design to a motor vehicle with large space restrictions, it is possible to expect an effect of reducing the fittings and the valves due to the reduction in the mounting number of the pressure vessels.

In particular, according to certain embodiments of the present invention, in order to solve the pressure distribution problem with an increase in the capacity of the pressure vessel, one non-cylindrical vessel may be substituted for two vessels of cylindrical shape through prediction of multi-scale physical properties. In certain embodiments, it is possible to apply the hybrid material and design a strong bulkhead, and thus, it is possible to achieve an improvement in productivity and minimization of the volume of the pressure vessel.

Hereinafter, examples of embodiments of the present invention will be described in detail, but the present invention is not limited to the following examples.

### EXAMPLES AND COMPARATIVE EXAMPLES

Non-cylindrical pressure vessels each having a bulkhead were manufactured under the conditions illustrated in Table 1 below. Here, a bulkhead reinforcing plate is used, and rigidities of the materials of the bulkhead reinforcing plates are compared with each other by changing the materials.

In the examples and the comparative examples, the implementation was diversified via a modified experimental example as follows for consideration of the influences of the material and thickness of the bulkhead.

### Comparative Example 1

In a case where the material of the bulkhead reinforcing plate used is polyamide 6, when an internal pressure 730 bar is applied, the deformation rate is 111 mm.

### Example 1

In a case where the bulkhead reinforcing plate material is thermoplastic CFRP (manufactured by thermoplastic prepreg compression molding based on PA6), when an internal pressure 730 bar is applied, the deformation rate decreases to 35.6 mm.

### Example 2

In a case where the bulkhead reinforcing plate material is identical to the thermoplastic CFRP of Example 1 and the thickness is doubled, when an internal pressure 730 bar is applied, the deformation rate is 31.5 mm.

### Comparative Example 2

In a case where the bulkhead reinforcing plate material is polyamide 6, there is one bulkhead, and the space is divided into two sections, when an internal pressure 730 bar is applied, the deformation rate is 131.0 mm.

As a result of the above-mentioned experiment, a conclusion such as following Table 1 was obtained.

TABLE 1

| | | | Thick- | | Max | Max | Max | |
|---|---|---|---|---|---|---|---|---|
| | No. | Hole | ness | | Stress | Stress | Deflec- | Vol- |
| Classi- | of | Size | of | Material | vessel | wall | tion | ume |
| fication | walls | (mm) | wall | of wall | (MPa ) | (MPa) | (mm) | (L) |
| Com- | 2 | 35 | 10 mm | PA | 10,530 | 1260 | 111.0 | 95.5 |
| parative | | | | 6Liner | | | | |
| Exam- | | | | | | | | |
| ple 1 | | | | | | | | |
| Exam- | 2 | 35 | 10 mm | Thermo- | 6,720 | 2,071 | 35.6 | 95.5 |
| ple 1 | | | | plastic | | | | |
| | | | | CFRP | | | | |
| Exam- | 2 | 35 | 20 mm | Thermo- | 6,368 | 1,229 | 31.5 | 91.5 |
| ple 2 | | | | plastic | | | | |
| | | | | CFRP | | | | |
| Com- | 1 | 35 | 10 mm | PA 6 | 12,5000 | 1700 | 131.0 | 97.5 |
| parative | | | | | | | | |
| Exam- | | | | | | | | |
| ple 2 | | | | | | | | |

From this result, it was confirmed that the bulkhead is much influenced by the elastic modulus of the bulkhead reinforcing material than the thickness of the bulkhead, and the configuration of embodiments of the present invention is very desirable.

Also, it was confirmed that, in certain embodiments, the thermoplastic carbon fiber composite material is most suitable in terms of the reduction in volume of the pressure vessel due to the bulkheads and the improvement in productivity.

### Reference Example

A volume change in accordance with the thickness of the wall and the volume of the wall of the non-cylindrical pressure vessel having the bulkhead was observed.

The result is illustrated in the following Table 2.

TABLE 2

| No of | Wall Thick- | Gas charge capacity | Wall | CNG |
|---|---|---|---|---|
| wall | ness (mm) | (L) except wall | Volume (L) | Volume (L) |
| 1 | 10 | 99.5 | 2 | 97.5 |
| 1 | 20 | 99.5 | 4 | 95.5 |
| 2 | 10 | 99.5 | 4 | 95.5 |
| 2 | 20 | 99.5 | 8 | 91.5 |

When comparing the results of Example 1 with Example 2 in Table 1, it is possible to know from Table 2 that, as the thickness of the bulkhead is increased from 10 to 20 mm in the same material, the difference of the maximum deformation rate is only 4.1 mm, but the charge capacity of the whole of the pressure vessel decreases to 2 to 4 L.

Thus, in order to maximize the space efficiency of the pressure vessel, it is desirable to design in a direction of improving the rigidity of the bulkhead and minimizing the thickness.

The non-cylindrical pressure vessel having the bulkhead according to embodiments of the present invention is easily applied to a pressure tank which compresses and contains the various types of fluid, and is particularly suitably applied to an automotive pressure vessel, a hydrogen storage tank or the like.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A method for manufacturing a pressure vessel, the method comprising:
blow-molding a liner vessel in a shape having at least one bulkhead and two or more separated spaces;
inserting a bulkhead reinforcing plate between the separated spaces;
forming an outer layer comprising a glass fiber or a glass fiber-carbon fiber composite material on the outside of the liner vessel; and
forming at least one anchor site configured to couple the bulkhead reinforcing plate to the outer layer.

2. The method of claim 1, wherein the bulkhead reinforcing plate is made of a thermoplastic carbon fiber composite material.

3. The method of claim 1, wherein the step of forming the outer layer comprises applying a filament winding.

4. The method of claim 1, wherein the liner vessel comprises Polyamide 6 material having low gas permeability.

5. The method of claim 1, wherein the bulkhead reinforcing plate is configured to be separated into left and right sides or upper and lower sides and to be fastened to the at least one bulkhead of the liner vessel from the left and right sides or the upper and lower sides.

6. The method of claim 1, wherein in the step of forming the at least one anchor site, the anchor site is manufactured separately from the bulkhead reinforcing plate.

7. The method of claim 1, wherein in the step of forming the at least one anchor site, the at least one anchor site is formed integrally with the bulkhead reinforcing plate.

8. The method of claim 7, wherein the at least one anchor site is protrusion-molded.

9. The method of claim 1, wherein the at least one anchor site includes two or four anchor sites formed at symmetric positions.

10. A pressure vessel comprising:
a liner vessel made of a plastic material having at least one bulkhead and two or more separated spaces;
a bulkhead reinforcing plate configured to reinforce the at least one bulkhead of the liner vessel by being inserted between the separated spaces of the liner vessel;
an outer layer comprising a glass fiber or a glass fiber-carbon fiber composite material, the outer layer formed on the outside of the liner vessel; and
at least one anchor site provided at an outer surface of the outer layer and the bulkhead reinforcing plate and is configured to prevent the bulkhead reinforcing plate from being substantially displaced due to pressure.

11. The pressure vessel of claim 10, wherein the at least one anchor site is manufactured separately from the bulkhead reinforcing plate.

12. The pressure vessel of claim 10, wherein the at least one anchor site is formed integrally with the bulkhead reinforcing plate.

13. The pressure vessel of claim 12, wherein the at least one anchor site is protrusion-molded.

14. The pressure vessel of claim 10, wherein the at least one anchor site includes two or four anchor sites formed at symmetric positions.

15. The pressure vessel of claim 10, wherein the bulkhead reinforcing plate comprises a thermoplastic carbon fiber composite material.

16. The pressure vessel of claim 10, wherein the outer layer is formed on the outside of the liner vessel by applying filament-winding.

17. The method of claim 10, wherein the liner vessel comprises Polyamide 6 material having low gas permeability.

18. A vehicle comprising the pressure vessel of claim 6.
